(19) United States
(12) Patent Application Publication
(10) Pub. No.: US 2011/0143226 A1
(43) Pub. Date: Jun. 16, 2011

(54) Metal Oxygen Battery Containing Oxygen Storage Materials

(75) Inventors: Andrea Pulskamp, Plymouth, MI (US); Andrew Robert Drews, Ann Arbor, MI (US); Jun Yang, Ann Arbor, MI (US); Shinichi Hirano, West Bloomfield, MI (US); Michael Alan Tamor, Toledo, OH (US)

(73) Assignee: FORD GLOBAL TECHNOLOGIES, LLC, Dearborn, MI (US)

(21) Appl. No.: 12/828,399

(22) Filed: Jul. 1, 2010

(51) Int. Cl. H01M 8/22

(52) U.S. Cl. 429/405

(57) ABSTRACT

According to one aspect of the present invention, a battery system is provided. In one embodiment, the battery system includes a metal oxygen battery including a first electrode and a second electrode, the second electrode including a metal material (M); and an oxygen containment unit in communication with and external to the metal oxygen battery, the oxygen containment unit including an oxygen storage material. In another embodiment, the metal oxygen battery and the oxygen containment unit are in a closed-loop with respect to each other.

### BACKGROUND

1. Technical Field

One or more embodiments of the present invention relate to oxygen storage materials as a source of oxygen for metal oxygen batteries and their method of use.

2. Background Art

There are many power storage and generation devices for vehicles. For instance, a fuel cell is a thermodynamically open system in which a fuel, such as hydrogen, irreversibly reacts with an oxidant, such as oxygen, to form water and electrical energy. By contrast, a battery is an electrochemical device that is often formed of a number of separate electrochemical battery cells interconnected to a single set of terminals providing an electrical output.

### SUMMARY

According to one aspect of the present invention, a battery system is provided. In one embodiment, the battery system includes a metal oxygen battery including a first electrode and a second electrode, the second electrode including a metal material (M); and an oxygen containment unit in communication with and external to the metal oxygen battery, the oxygen containment unit including an oxygen storage material.

In another embodiment, the first electrode is a cathode and the second electrode is an anode.

In another embodiment, the metal oxygen battery and the oxygen containment unit are in a closed-loop with respect to each other.

In yet another embodiment, the battery system further includes a conduit extending between the oxygen containment unit and the metal oxygen battery, the oxygen containment unit being in fluid communication with the metal oxygen battery through the conduit. In certain instances, the conduit includes a first conduit and an opposing second conduit, the opposing second conduit communicating oxygen from the metal oxygen battery to the oxygen containment unit.

In yet another embodiment, the battery system is for use in a vehicle under a range of operation conditions, the range of operating conditions including an operational temperature range of 230 to 310 degrees Kelvin for the metal oxygen battery and an operational temperature range of 77 to 500 degrees Kelvin for the oxygen containment unit. In certain instances, the range of operating conditions including an operational pressure range of 1 to 100 bar for the metal oxygen battery and an operational pressure range of 1 to 700 bar for the oxygen containment unit. In certain other instances, the oxygen containment unit has an oxygen volumetric capacity of at least 10 grams of oxygen per liter of the oxygen containment unit under the operational pressure range. In certain other instances, the range of operating conditions includes an oxygen flow rate smaller than an air flow rate of a conventional metal air battery. In yet another embodiment, the metal oxygen battery further includes a gas flow field in communication with the oxygen containment unit. In certain instances, the gas flow field has a field volume, and the volume ratio of the field volume relative to the total volume of the metal oxygen battery is in a range of 40 to 80 volume percent. In certain other instances, the gas flow field has a unit density less than a unit density of the cathode.

In yet another embodiment, the battery system further includes a control module regulating the fluid communication between the oxygen containment unit and the metal oxygen battery. In certain instances, the metal oxygen battery further includes a gas flow field, the control module including a valve disposed between the cathode and the gas flow field. In certain other instances, the metal oxygen battery, the control module, and the oxygen containment unit are in a closed-loop with respect to each other. In certain other instances, the control module includes a valve disposed on the conduit. In certain other instances, the control module is configured to increase, decrease and/or stop oxygen flow from the oxygen containment unit to the metal oxygen battery.

In yet another embodiment, the oxygen containment unit has a first operating state of oxygen absorption into the oxygen storage material and a second operating state of oxygen desorption from the oxygen storage material.

According to another aspect of the present invention, a battery system is provided. The battery system includes a reversible closed-loop conduit communicating with an oxygen storage material and a metal oxygen battery, the reversible closed-loop conduit including an input and an output, the input of the reversible closed-loop conduit communicating with the output of the metal oxygen battery and the output of the reversible closed-loop conduit communicating with the input of the oxygen storage material.

According to yet another aspect of the present invention, a method of using a battery system is provided. In one embodiment, the battery system includes communicating oxygen from a metal oxygen battery into a reversible closed-loop conduit; and communicating oxygen to an oxygen storage material from the reversible closed-loop conduit.

### BRIEF DESCRIPTION OF THE DRAWINGS

FIG. 1 depicts an illustrative view of a battery system for use in a vehicle according to one embodiment of the present invention;

FIG. 2 illustrates a top view of an electric vehicle including a metal oxygen battery or a metal oxygen battery system according to another embodiment of the present invention; and

FIG. 3 depicts different views of a battery system according to yet another embodiment of the present invention.

### DETAILED DESCRIPTION

Reference will now be made in detail to embodiments of compositions, structures, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

There are many power storage and generation devices for vehicles. For instance, a fuel cell is a thermodynamically open system in which a fuel, such as hydrogen, irreversibly reacts with an oxidant, such as oxygen, to form water and electrical energy. By contrast, a battery is an electrochemical device that is often formed of a number of separate electrochemical battery cells interconnected to a single set of terminals providing an electrical output.

Electrochemical battery cells can include numerous configurations and chemistries, including primary or non-rechargeable battery cells and secondary or rechargeable battery cells. Non-limiting examples of a secondary battery cell include a lithium ion cell, a metal hydride cell, a metal-air battery cell, and a metal-oxygen battery cell. In general, a secondary battery cell is capable of storing electrical energy chemically, and the chemical storage often involves a reversible redox reaction. In the uncharged state, the redox reaction does not start spontaneously, and, in such cases, the secondary battery cell needs to be charged initially in order to store energy.

In one example of a secondary battery cell, a lithium ion cell includes a layered oxide positive electrode including lithium in ionic communication with a graphite negative electrode through a non-aqueous electrolyte and a separator. During charging, lithium is ionized from the layered oxide positive electrode and migrates through the electrolyte and separator to the negative electrode and becomes embedded in the porous negative electrode composition by the process of intercalation. During a discharge half step, the intercalation composition decomposes allowing current to flow within the battery cell by the movement of lithium ions from the negative electrode to the positive electrode.

In another example of a secondary battery cell, the metal hydride battery cell includes a metal oxyhydroxide positive electrode, such as a nickel oxyhydroxide, electrically communicating with a metal alloy negative electrode. The metal alloy negative electrode is a hydrogen storage alloy negative electrode. The hydrogen storage alloy includes a material reversibly forming a mixture of metal hydride compounds. In certain instances, the hydrogen storage alloy includes an intermetallic material having two or more solid phase metallic elements.

In yet another example of a secondary battery cell, a metal air battery cell is, in typical configurations, an open system with respect to material flow, heat transfer, and work. For instance, a metal air battery cell is provided with holes, openings, or vents, which mediate air transport between the metal air battery and atmospheric air. For most metal air batteries, moisture and interfering gases from the air often need to be filtered, eliminated, or trapped prior to the air's being introduced to the metal air battery. For instance, the metal air battery cell includes an air positive electrode electrically communicating with a metal negative electrode through an electrolyte and a separator. The air positive electrode, in typical configurations, includes a carbon composition positive electrode. During the charge reaction, oxygen is released to the ambient air.

Metal oxygen batteries (MOBs) are conventionally characterized as a subgroup of the metal air batteries as oxygen is commonly involved for the electrochemical reactions. MOBs are known to have relatively high electrochemical capacities, and are therefore of great interest for applications where the total mass of a given battery is limited. Implementation of conventional MOBs has been met with difficulties in that their performance, both in terms of capacity and power, has been largely unsatisfactory. The limited performance is believed to be at least in part associated with incomplete or slow reactions involving the arrival and diffusion of oxygen molecules. For an MOB to achieve its full discharge capacity, sufficient quantities of oxygen must be made available in a timely manner. In addition, since the rate of discharging is tied to the formation and growth of the positive electrode oxide, the battery's rate of discharging at least in part depends on the more rate limiting processes of oxygen diffusion.

In one or more embodiments, the term metal oxygen battery (MOB) refers to a battery structure that differs from conventional metal oxygen/air batteries at least in that the MOB is relatively closed to atmospheric air and oxygen for reactions is relatively devoid of unwanted species such as nitrogen or carbon dioxide.

In one or more embodiments, the term “electrode” may refer to a structure through which charges are carried by electromotive force. Electrodes may be composed of one or more metal and/or semiconductor. Electrodes may be solid or liquid.

In one or more embodiments, the term “electrolyte” refers to a material and/or structure through which charges are carried by the movement of ions. Electrolytes may be any phase on the continuum of liquid to solid, including polymer gels, pastes, fused salts, ionic liquids, organic carbonates, or ionically conducting solids, such as sodium β-alumina, which has mobile sodium ions.

In one or more embodiments, metal-oxygen batteries (MOBs) may refer to a class of electrochemical cells in which, during discharging, oxygen is reduced at a positive electrode surface as part of the electrochemical cell reaction. Reduction of the oxygen forms an oxide or peroxide ion which reacts with a cationic metal species. Metal-oxygen batteries may be based upon Fe, Zn, Al, Mg, Ca, and Li.

MOBs, such as Li⁺ based MOBs, have recently been demonstrated experimentally in a small number of laboratories. However, implementation of conventional MOBs has been largely unsuccessful because their performance, both in terms of capacity and power, has been unsatisfactory for vehicle applications. The limited performance is believed to be likely associated with incomplete or slow reactions involving the arrival and dissociation of oxygen molecules from the atmospheric air. In particular, for a metal oxygen battery to achieve its full discharge capacity, sufficient quantities of oxygen should be made available in a timely manner. In addition, since the rate of discharge is tied to the formation and growth of the cathode oxide, the battery's rate of discharge depends in part on the more rate limiting processes of oxygen dissociation.

It has been found, according to one or more embodiments of the present invention, that the MOB performance can be greatly improved by one or more of the following approaches: (1) providing a relatively high concentration of oxygen at the positive electrode; and/or (2) increasing oxygen diffusion rate at the positive electrode.

One or more of the following benefits can be realized according to certain embodiments of the present invention: (1) requirements for many balance of plant (BOP) components including positive electrode flow field, blower, and air purification system, can be reduced or eliminated; (2) susceptibility to contamination from atmospheric air impurities can be reduced or eliminated; (3) battery system flexibility may be increased and packaging costs can be reduced; (4) battery cell manufacturing procedures may be simplified; and/or (5) improved battery performance kinetics may be realized via a reduction in bulk diffusion and an increase in surface diffusion.

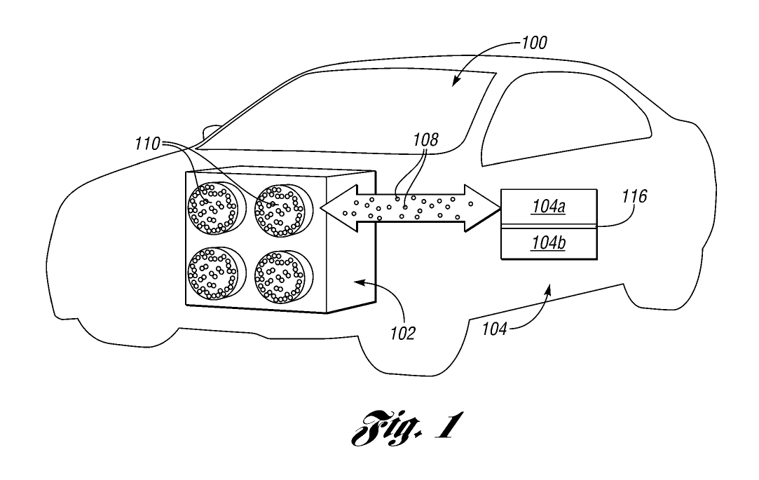

According to one aspect of the present invention, a battery system is provided. In one embodiment, and as depicted in FIG. 1, a battery system generally shown at 100 includes a metal oxygen battery 104 having a first electrode 104a and a second electrode 104b, the second electrode 104b including a metal material M (not shown); and an oxygen containment unit 102 in communication with the metal oxygen battery 104. The oxygen containment unit includes an oxygen storage material “OSM” 110. In certain instances, the oxygen containment unit 102 is in fluid communication with the metal oxygen battery 104, and in certain particular instances the fluid is oxygen.

In one or more embodiments, the metal material M includes one or more elemental metal listed in the periodic table and/or one or more alloys formed of a mixture of two or more of the elemental metals. A non-limiting list of the elemental metals includes alkali metals, alkaline earth metals, transition metals and post-transition metals.

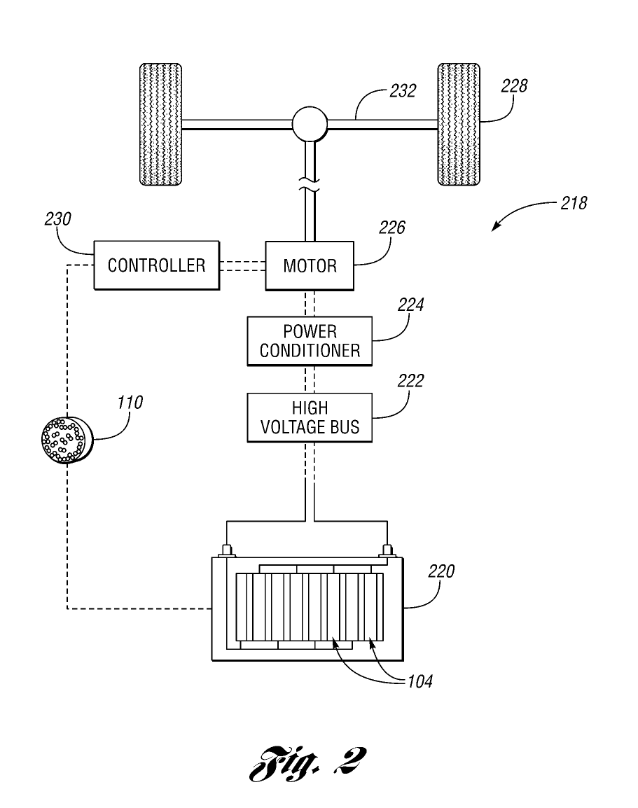

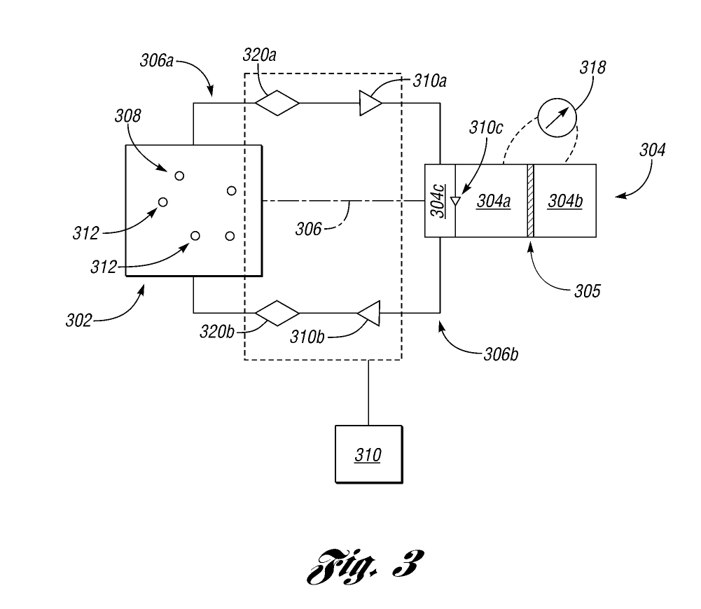

FIG. 2 illustrates a top view of an electric vehicle including a metal oxygen battery or a metal oxygen battery system according to another embodiment of the present invention. As illustratively depicted in FIG. 2, connected to vehicle 218 is a metal oxygen battery (MOB) system 220 electrically communicating directly or indirectly with a controller 230. In certain instances, the MOB or MOB system 220 is the MOB 104 referenced in FIG. 1 or the MOB 304 in FIG. 3. The controller 130 electrically communicates with a traction motor 226. Traction motor 226 is connected to at least one wheel 228 of the vehicle 218. In certain instances, MOB battery system 220 electrically communicates with and provides energy to a high-voltage bus 222. High-voltage bus 222 electrically communicates with and provides energy to a power conditioner 224. The power conditioner 224 electrically communicates with the traction motor 226 which is connected directly or indirectly to wheel 228 situated on a frame 232. In certain instances, and as illustratively depicted in FIG. 2, the controller 230 controls oxygen communication between the MOB system 220 and the OSM 110, and particularly oxygen release from and/or storage into the OSM 110.

According to another aspect of the present invention, a battery system is provided. In one embodiment, and as depicted in FIGS. 3A and 3B, the battery system generally shown at 300 includes a metal oxygen battery 304 including a first electrode 304a and a second electrode 304b, the second electrode 304b including a metal material M (not shown); and an oxygen containment unit 302 in communication with and external to the metal oxygen battery 304, the oxygen containment unit 302 including an oxygen storage material 308.

In certain instances, such as during discharging, the first electrode 304a functions as a positive electrode or a cathode, and the second electrode 304b functions as a negative electrode or an anode. In certain other instances such as during charging, the first electrode 304a may function as a negative electrode or an anode, and the second electrode 304b may function as a positive electrode or a cathode. In these instances, the term “positive electrode” refers to an electrode with a positive polarity, and the term “negative electrode” refers to an electrode with a negative polarity.

In another embodiment, and as depicted in FIGS. 3A and 3B, the metal oxygen battery 304 and the oxygen containment unit 302 are in a closed-loop with respect to each other. In certain instances, the metal oxygen battery 304 and the oxygen containment unit 302 are in a closed-loop with respect to material flow, such as oxygen flow, while being receptive to heat transfer or work with the surrounding environment.

In yet another embodiment, and as depicted in FIG. 3, the battery system 300 further includes a first conduit 306a and a second conduit 306b extending between the oxygen containment unit 302 and the metal oxygen battery 304, the oxygen containment unit 302 being in fluid communication with the metal oxygen battery 304 through the first and second conduit 306a, 306b. Optionally, and as depicted in FIG. 3, the first and second conduit 306a, 306b can be replaced with a single conduit generally shown at 306.

It is appreciated that in one or more embodiments, the oxygen containment unit 102 may be open for venting the residual oxygen out and/or for reloading fresh oxygen, as oxygen is readily available.

In yet another embodiment, the oxygen containment unit 302 has a first operating state and a second operating state different from the first operating state. In certain instances, and as depicted in FIG. 3, the first operating state of the oxygen containment unit 302 includes absorption of oxygen 312 into the oxygen storage material 310. Conversely, the second operating stage of the oxygen containment unit 302 includes desorption of oxygen 312 from the oxygen storage material 310. The first operation state of the oxygen containment unit 302 may be closely related to a corresponding operation state of the metal oxygen battery 304 wherein oxygen 312 is being returned back from the metal oxygen battery 304 via the opposing second conduit 306b, for instance, during and after a battery charging process. The second operation state of the oxygen containment unit 302 may be closely related to a corresponding operation state of the metal oxygen battery 304 wherein oxygen 312 is released into the metal oxygen battery 304 via the first conduit 306a, for instance, during and after a discharging process.

Without being limited to any particular theory, it is believed that during electrical discharging, metal M is oxidized to form metal cation M⁺ at the second electrode 304b which functions as an anode. The metal cation M⁺ flows from the anode through an electrolyte and combines with reduced oxygen anion O₂⁻ or O⁻ to form metal oxide MₓO₂ at the first electrode 304a which functions as a cathode, wherein value x is the charge balance dependent upon the valence of the metal M. In certain instances, the metal oxide MₓO₂ is inserted in the cathode. This process of electrical discharging is coupled to the flow of electrons from the second electrode 304b, functionally an anode in this instance, to the first electrode 304a, functionally a cathode in this instance, via a load circuit illustratively shown at 318 in FIG. 3.

In this configuration, it is appreciated that the MOB 304 is substantially free of water molecules and particularly liquid water molecules.

In one or more embodiments, the term “substantially free” refers to an extent of being less than 1000 parts per million (ppm), less than 500 ppm, less than 200 ppm, less than 100 ppm, or less than 50 ppm. In some instances means that a substance, such as water, is not purposefully added and whose presence, if any, is only incidental.

In yet another embodiment, the oxygen containment unit 102 includes relatively pure oxygen species in that any other gas or fluid species, such as nitrogen (N₂), is not present or only incidentally present at a nominal amount. This is in direct contrast to atmospheric air wherein nitrogen has a relatively significant presence relative to oxygen. In certain instances, when incidentally present, nitrogen is less than 1000 ppm, less than 500 ppm, less than 100 ppm, or less than 50 ppm.

As stated herein, one of the advantages of the present invention, in one or more embodiments, is that oxygen can be stored in the oxygen storage material 110 with a relatively high concentration and/or density as unusable or interfering gas molecules such as nitrogen can be effectively avoided. As a result, an oxygen material flow communicating between the MOB 104 and the OSM 110 can be achieved in a relatively how flow rate, which further reduces system costs associated with effecting and maintaining otherwise relatively high flow rate operations.

In yet another embodiment, the oxygen containment unit 302 is an oxygen physisorption containment unit wherein substantial amount of the oxygen molecules 312 contained within the oxygen containment unit 302 is disposed within and/or onto the OSM 310 via physisorption. Without being limited to any particular theory, it is believed that physisorption occurs when absorbate, such as oxygen, adheres to the surface only through van der Waals interactions, which are relatively weak intermolecular forces. The physisortpion may be characterized by one or more of the following additional features: (1) having relatively low enthalpy, such as fewer than 40 KJ/mol; (2) with absorption taking place in two or more layers; (3) requiring relatively low activation energy such as less than 100 KJ/mol; (4) with the energy state of OSM not being altered; and (5) OSM absorption being reversible.

It is appreciated that oxygen physisorption being able to take place on two or more layers of the OSM makes OSM a particularly suitable oxygen carrier for use on board a vehicle. Without being limited to any particular theory, it is believed that oxygen concentration is a function of distance from the OSM surface. The following U.S. patent application Ser. Nos. ______, ______, ______, ______, and ______, all filed on ______, disclosed relevant characteristics of oxygen storage materials as a suitable carrier for oxygen in on-board uses. Each of the identified applications is incorporated herein by reference in their entirety.

In yet another embodiment, the oxygen containment unit 302 is a sealed containment unit. In this configuration, it is appreciated that there exists no intentionally or purposefully designed material exchange between the oxygen containment unit 302 and the external environment, other than the conduits 306a, 306b mediating the fluid communication between the oxygen containment unit 302 and the metal oxygen battery 304. In certain instances, the oxygen containment unit is sealed and has an exterior substantially impermeable to the atmospheric air or any components thereof, such as oxygen and nitrogen.

In one or more embodiments, the oxygen containment unit 302 may be a gas tank formed of any suitable materials such as metal and synthetic polymers. In certain instances, the oxygen containment unit 302 can be of all metal construction. Unlike conventional air/oxygen tank wherein high pressure is needed to keep the oxygen compressed within the tank, the oxygen containment unit 302 can keep the oxygen physiosorbed onto the oxygen storage material or sorbent. As a result, low pressure vessels such as all metal tanks can be used as the oxygen containment unit 302 and therefore additional cost advantages can be realized.

In certain other instances, such as when an operational pressure of 100 bar or above is needed, the oxygen containment unit 302 can be formed of a load-bearing metal liner with hoop wrapped fiber reinforcement. This type of gas tank is relatively lighter than all-metal type of gas tanks. Other gas tanks formed of a non-load-bearing liner and full-wrapped fiber reinforcement may also be used. For instance, these other types of gas tanks may be provided with a metal inner liner and/or a plastic liner for reducing or preventing oxygen diffusion. Any of these types of gas tanks may be modified for operations in particular uses.

In one or more embodiments, improved robustness may be realized with the implementation of the oxygen storage in containers operable under relatively less stringent pressure and/or temperature. In one or more embodiments, the oxygen containment unit 302 may be operable at a pressure of less than 700 bar, 600 bar, 500 bar, 400 bar, 300 bar, 200 bar. Moreover, the reduction in operating pressure also improves the potential robustness due to the associated stress levels. A relatively higher pressure system often requires additional stresses and failure modes, which could increase the system cost and design complexity to manage these robustness items including sealing, permeation, and metal embrittlement. For instance the tanks configured for operation at 200 bar or lower are significantly less costly relative to 700 bar tanks.

In yet another embodiment, the battery system 300 is for use in a vehicle under a range of operation conditions, wherein the battery system 300 can be operated with a temperature range of 230 to 310 degrees Kelvin for the metal oxygen battery 304 and an operational temperature range of 77 to 500 degrees Kelvin for the oxygen storage material 308. In certain instances, the battery system 300 can be operated with an operational pressure range of 1 to 100 bar for the metal oxygen battery 304 and an operational pressure range of 1 to 700 bar for the oxygen storage material 308. In certain other instances, the oxygen containment unit has an oxygen volumetric capacity of at least 10 grams of oxygen per liter of the oxygen containment unit under the operational pressure range. In certain other instances, an oxygen flow rate between the metal oxygen battery 304 and the oxygen containment unit 302 is reduced relative to an air flow in a conventional metal air battery, by a factor of 2, 3, 4, or 5.

In yet another embodiment, and as depicted in FIG. 3, the metal oxygen battery 304 further includes a gas flow field 304c in communication with the oxygen containment unit 302. Without being limited to any particular theory, it is believed that the gas flow field 304c helps redirect an incoming oxygen flow through the first conduit 306a and helps increase the contacting surface between the oxygen flow and the cathode 304a. In certain instances, a separator 305 separates the first and second electrodes 304a, 304b. In certain instances, the gas flow field 304c is provided with a field volume, and the volume ratio of the field volume relative to the total volume of the metal oxygen battery is in a range of 40 to 80 volume percent. The field volume defining the gas flow field 304c is a purposefully designed volume to facilitate and redirect the incoming oxygen flow. The gas flow field 304c may be an empty space or may be filled with some porous light weight materials to further an even distribution of oxygen. In either scenario, it is appreciated that the gas flow field 304c has a unit density less than a unit density of the cathode 304a.

In yet another embodiment, and as depicted in FIG. 3, the battery system 300 further includes a control module 310 regulating the fluid communication, and particularly oxygen communication, between the oxygen containment unit 302 and the metal oxygen battery 304. In certain instances, the control module 310 includes a first valve 310a disposed within the first conduit 306a and a second valve 310b disposed within the opposing second conduit 306b. In certain instances, the metal oxygen battery further includes a gas flow field, the control module 310 further includes a third valve 310c disposed between the cathode 304a and the gas flow field 304c. In certain other instances, the metal oxygen battery, the control module, and the oxygen containment unit are in a closed-loop with respect to each other. In one or more embodiments, the control module 310 is configured to increase, decrease, and/or stop oxygen flow from the oxygen containment unit 302 to the metal oxygen battery 304, and from the metal oxygen battery 304 to the oxygen containment unit 302.

In yet another embodiment, and as depicted in FIG. 3, the control module 310 may further include a first pump 320a. The first pump 320a may be provided in connection with the first conduit 306a for increasing oxygen flow from the oxygen containment unit 302 to metal oxygen battery 304. In this arrangement, both the first pump 320a and the first valve 310a may be controlled by the control module 310. For instance, the control module 310 directs the first pump 320a to be at an “on” or “off” position, to respectively direct a pumping or not to pump of an oxygen flow. Additionally, the oxygen flow from the first pump 320a may be modified by an extent of valve opening of the first valve 310a, which is also controllable by the control module 310.

In yet another embodiment, and as depicted in FIG. 3, the control module 310 may further include a second pump 320b. The second pump 320b may be provided in connection with the second conduit 306b for increasing oxygen flow from the metal oxygen battery 304 back to the oxygen containment unit 302. In this arrangement, both the second pump 320b and the second valve 310a may be controlled by the control module 310. For instance, the control module 310 directs the second pump 320b to be at an “on” or “off” position, to respectively direct a pumping or not to pump of an oxygen flow. Additionally, the oxygen flow from the second pump 320b may be modified by an extent of valve opening of the second valve 310b, which is also controllable by the control module 310.

In yet another embodiment, the oxygen containment unit 302 has a first operating state of oxygen absorption into the oxygen storage material 308 and a second operating state of oxygen desorption from the oxygen storage material 308.

According to another aspect of the present invention, a battery system is provided. The battery system includes a reversible closed-loop conduit communicating with an oxygen storage material and a metal oxygen battery, the reversible closed-loop conduit including an input and an output, the input of the reversible closed-loop conduit communicating with the output of the metal oxygen battery and the output of the reversible closed-loop conduit communicating with the input of the oxygen storage material.

According to yet another aspect of the present invention, a method of using a battery system is provided. In one embodiment, the battery system includes communicating oxygen from a metal oxygen battery into a reversible closed-loop conduit; and communicating oxygen to an oxygen storage material from the reversible closed-loop conduit.

In one or more embodiments, the metal-oxygen battery cell undergoes reversible redox reactions. During the discharging reaction, the oxygen reacts with a metal cation from the metal negative electrode, the oxygen is released at the oxygen positive electrode and reacts with a metal cation from the metal negative electrode, forming a mixed oxide metal oxide, including a metal oxide and/or a metal peroxide which is then situated at the positive electrode. During the charging reaction, the metal mixed oxide metal oxide decomposes, releasing oxygen which, in at least one embodiment, is stored in a metal oxygen framework (MOF) composition at the positive electrode. The metal cation migrates back to the negative electrode reacquiring an electron from the negative electrode and forming a metal composition.

Oxygen storage materials (OSMs) may be utilized as storage materials for oxygen by providing appreciable surface area for enhancing oxygen uptake. Desirable on-board operating conditions illustratively include near ambient temperature (T) (e.g., 150 K to 400 K) and modest pressure (P) (e.g., 1 to 100 bar) to avoid added cost or system complexity. Particularly suitable binding energies for oxygen material storage may be determined based on the Clausius-Claeypron Equation of the form:

$$ln P = \frac{- Δ H}{R} \frac{1}{T}$$

where P is the partial pressure of oxygen, ΔH is the sorbent oxygen binding energy, R is a constant, and T is the temperature in degrees Kelvin of the oxygen. In certain other instances, the OSM has an oxygen oxygen binding energy, or particularly an isosteric adsorption enthalpy, ranging from 5 kJ/mol.O₂ to 100 kJ/mol.O₂, or 7 kJ/mol.O₂ to 70 kJ/mol.O₂, or to 10 kJ/mol.O₂ to 40 kJ/mol.O₂.

In one or more embodiments, OSMs can be utilized as oxygen storage materials for oxygen in terms of having relatively high material density. The volumetric storage capacity of an OSM may be related to the gravimetric capacity and material density for the OSM. As a non-limiting example, if a given OSM has a gravimetric capacity of 0.3 kg of oxygen per kg and a materials density of 0.2 g/mL, a corresponding volumetric capacity would be 60 g of oxygen per liter of OSM. Storing 8 kg of oxygen would use 133 liters of OSM. However, if the material density is 1 g/mL, only 27 liters of OSM would be required.

Without being limited to any particular theory, it is appreciated that the OSMs are generally provided with a relatively high-surface area, which facilitates oxygen uptake or adsorption by processes such as physiosorption. Such oxygen uptake scales linearly with surface area as measured using any suitable method such as the BET method. In certain instances, the surface area of the OSM exceeds 1000 m²/g, from 2000 m²/g to 8000 m²/g, or from 3000 m²/g to 6000 m²/g.

In one or more embodiments, it is appreciated that oxygen molecules as described herein may include oxygen species other than oxygen, such as diatomic oxygen, ozone, and free radical oxygen species.

In certain instances, the OSM in the excess capacity has a gravimetric capacity for oxygen of greater than 10 grams per 100 grams of the OSM, or of between 20 to 80 grams per 100 grams of the OSM, or 25 to 50 grams oxygen per 100 grams of the OSM.

In certain other instances, the OSM has a material (single crystal) density greater than 0.1 g/mL, or of from 0.25 g/mL to 5 g/mL, or of from 0.5 g/mL to 2 g/mL.

In certain other instances, the OSM has a volumetric capacity for oxygen of greater than 2 g/L, or of from 16 g/L to 500 g/L, of or 32 g/L of to 300 g/L, or of from 50 g/L to 220 g/L.

In one or more embodiments to achieve the properties discussed above, the OSMs are porous, high surface area sorbent materials. Non-limiting examples of the OSMs include crystalline framework-like compounds such as metal-organic frameworks (MOFs), covalent organic frameworks (COFs), zeolitic imidazolate frameworks (ZIFs) and zeolitic materials; aerogel-like substances with nanometer or micrometer scale porosity, such as zero-gels and xero-gels; porous carbon materials such as porous carbon gels and porous carbon nanotubes; and porous metal substances such as porous metal oxides, porous metal carbides, porous metal nitride or other porous metal substances with internal sites that favorably form weak physical adsorption sites with oxygen.

Non-limiting examples of the MOFs include: a catalytically-active MOF-5 having embedded metal, such as Ag@[Zn₄O(BDC)₃], Pt@[Zn₄O(BDC)₃], Cu@[Zn₄O(BDC)₃], an Pd@[Zn₄O(BDC)₃]; an organically solvated MOF, such as Ti(OⁱPr)₄[Cd₃Cl₆(LI)₃.4DMF.6MeOH.3H₂O, Ti(OⁱPr)₄[Cd₃(NO₃)₆(LI)₄.7MeOH.5H₂O, Ti(OⁱPr)₄[Cd(LI)₂(H₂O)₂][ClO₄]₂.DMF.4MeOH.3H₂O, [Rh₂(M²⁺TCPP)₂], where M²⁺ may include Cu, Ni, or Pd, and [Zn₂(BPDC)₂(L2)].10DMF.8H₂O; an ionically or partially ionically solvated MOF, such as [Ni(L-aspartate)bpy_{0.5}]HCl_{0.9}MeOH_{0.5}, [Cu(L-aspartate)bpy_{0.5}]HCl, [Cu(D-aspartate)bpy_{0.5}]HCl, [Cu(L-aspartate)bpy_{0.5}]HCl, [Cu(D-aspartate)bpy_{0.5}]HCl, Cr₃(F,OH)(en)₂O(BDC)₃(ED-MIL-101), Cr₃(F,OH)(en)₂O(BDC)₃(ED-MIL-101), [Zn₃O(L3-H)].(H₃O)₂(H₂O)₁₂(D-POST-1), [Sm(L4-H₂)(L4-H₃)(H₂O)₄].(H₂O)ₓ, [Cu(bpy)(H₂O)₂(BF₄)(bpy)], [Zn₄O(BDC)₃](MOF-5), [Ln(OH)H₂O)(naphthalenedisulfonate)] where Ln includes a lanthanide metal such as Nd, Pr, or La; as well as [In₄(OH)₆(BDC)₃], [Cu₃(BTC)₂], [Sc₂(BDC)₃], [Sc₂(BDC)_{2.5}(OH)], [Y₂(BDC)₃(H₂O)₂].H₂O, [La₂(BDC)₃(H₂O)₂].H₂O, [Pd(2-pymo)₂], [Rh₂(H2TCPP)₂)BF₄, [Cu₂(trans-1,4 cyclohexanedicarboxylate)₂]H₂O, [Cu(2-pymo)₂], [Co(PhIM)₂], [In₂(BDC)₃(bpy)₂], [In₂(BDC)₂(OH)₂(phen)₂], [In(BTC)(H₂O)(bpy)], [In(BTC)(H₂O)(phen)], [Sc₂(BDC)_{2.5}(OH)], [Y₂(BDC)₃(H₂O)₂].H₂O, [La₂(BDC)₃(H₂O)₂]H₂O, [Cu₃(BTC)₂], [Cd(4,4′-bpy)₂(H₂O)₂]-(NO₃)₂.(H₂O)₄, [Sm(L4-H₂)(L4-H₃)(H₂O)₄].(H₂O)ₓ, Mn₃[(Mn₄Cl)(BTT)₈(MeOH)₁₀]₂, [Zn₄O(BDC)₃](MOF-5), Ti-(2,7-dihydroxynaphthalene)-MOF, [Pd(2-pymo)₂], [Cu₃(BTC)₂], [Cu₃(BTC)₂], [Cu₃(BTC)₂], [Rh₂(L5)], [Rh(BDC)], [Rh(fumarate)], [Ru(1,4-diisocyanobenzene)₂]Cl₂, [In₄(OH)₆(BDC)₃], [Ru₂(BDC)₂], [Ru₂(BPDC)₂], [Ru₂(BDC)₂(dabco)], [Ru₂(BPDC)₂(dabco)], [Rh₂(fumarate)₂], [Rh₂(BDC)₂], [Rh₂(H₂TCPP)₂], and [Pd(2-pymo)₂].

In one or more embodiments, the MOF is a porous coordination network (PCN) having at least one entactic metal center (EMC), such as PCN-9 MOF. The EMC is an unusual geometry imposed by a ligand on a metal center in the MOF for the purpose of enhancing the MOF's affinity for oxygen. Non-limiting examples of imposed geometry include adapting organic positive electrode units to generate a pore comparable to the size of the oxygen molecule and introducing a coordinatively unsaturated metal center, such as a metal cation cluster. A combination of several EMCs may create a secondary building unit (SBU) within the MOF suitable for exceptional gas sorption affinity as determined by adsorption isotherms collected at various temperatures and fitted using the Langmuir-Fruendlich equation.

When applied as an example of the OSM, and in certain instances, PCN-9 may be provided with an oxygen adsorption enthalpy greater than 12 kJ/mol.O₂, ranging from 15 kJ/mol.O₂ to 45 kJ/mol.O₂, from 17 kJ/mol.O₂ to 43 kJ/mol.O₂, or 18 kJ/mol.O₂ to 23 kJ/mol.O₂. PCN-9 has a fixed pore diameter ranging from 0.55 nm to 0.75 nm or 0.6 nm to 0.7 nm.

In certain instances, the MOF includes a solvated MOF formed from 1,4-benzenedicarboxylic acid (BDC) with a zinc metal cation cluster. A non-limiting example of the solvated MOF is Zn₄(μ-4O)(μ-BDC)₃.(DEF)₇, where DEF is diethylformamide, a solvent molecule.

An example of a manufacturing process for certain MOFs, such as the MOF-5, includes the steps of mixing a solution of terephthalic acid with a zinc salt, such as zinc nitrate to form a mixture. The mixture is crystallized or precipitated at a temperature ranging from 25° C. to 200° C. The precipitate is filtered from the solution and dried. It is appreciated that MOFs may be modified after synthesis via reactions such as oxidation, acetylization, hydrogenation, Knoevenagel condensation, and/or Heck coupling. Moreover, the MOFs may be activated by removing the solvent introduced during a crystallization and/or precipitation process.

In one or more embodiments, the second electrode 104b, which functions as an anode during discharging, includes a metal material (M). The metal material M may include a metal, such as an alkali metal, an alkaline-earth metal, or a transition metal. The metal material M may also include alloys of such metals, metal ceramics, superalloys, fusible alloys, metal intercalation compounds or materials, and amalgams. In certain particular instances, the metal material M includes an elemental monolith negative electrode, including, for example, Li or Na; a mixed material negative electrode, having an intercalation compound, such as graphite; and/or an alloy, such as a lithium-silicon alloy, a lithium aluminum alloy, and/or a lithium boron alloy.

In certain particular instances, the second electrode 104b is formed of elemental lithium metal. In certain other particular instances, the second electrode 104b includes an alloy of lithium.

The following applications disclose and claim battery systems that may be related to the battery system disclosed and claimed herein: U.S. patent application Ser. Nos. ______, ______, ______, ______, and ______, all filed on ______. Each of the identified applications is incorporated herein by reference in their entirety.

While the best mode for carrying out the invention has been described in detail, those familiar with the art to which this invention relates will recognize various alternative designs and embodiments for practicing the invention as defined by the following claims.

What is claimed:

1. A battery system comprising:
a metal oxygen battery including a first electrode and a second electrode, the second electrode including a metal material (M); and
an oxygen containment unit in communication with and external to the metal oxygen battery, the oxygen containment unit including an oxygen storage material.

2. The battery system of claim 1, wherein the first electrode is a cathode and the second electrode is an anode.

3. The battery system of claim 1, wherein the metal oxygen battery and the oxygen containment unit are in a closed-loop with respect to each other.

4. The battery system of claim 1, further comprising a conduit extending between the oxygen containment unit and the metal oxygen battery, the oxygen containment unit being in fluid communication with the metal oxygen battery through the conduit.

5. The battery system of claim 4, wherein the conduit includes a first conduit and a second conduit, the second conduit communicating oxygen from the metal oxygen battery to the oxygen containment unit.

6. The battery system of claim 1 for use in a vehicle under a range of operation conditions, the range of operating conditions including an operational temperature range for the metal oxygen battery of 230 to 310 degrees Kelvin and an operational temperature range for the oxygen containment unit of 77 to 500 degrees Kelvin.

7. The battery system of claim 1 for use in a vehicle under a range of operation conditions, the range of operating conditions including an operational pressure range of 1 to 100 bar for the metal oxygen battery and an operational pressure range of 1 to 700 bar for the oxygen containment unit.

8. The battery system of claim 1 for use in a vehicle under a range of operating conditions, wherein the oxygen containment unit has an oxygen volumetric capacity of at least 10 grams of oxygen per liter of the oxygen containment unit under the operational pressure range.

9. The battery system of claim 1, wherein the metal oxygen battery is substantially free of water molecules.

10. The battery system of claim 1, wherein the metal oxygen battery further includes a gas flow field in communication with the oxygen containment unit.

11. The battery system of claim 10, wherein the gas flow field has a field volume, and the volume ratio of the field volume relative to the total volume of the metal oxygen battery is in a range of 40 to 80 volume percent.

12. The battery system of claim 10, wherein the gas flow field has a unit density less than a unit density of the first electrode.

13. The battery system of claim 1, further comprising a control module regulating the communication between the oxygen containment unit and the metal oxygen battery.

14. The battery system of claim 13, wherein the metal oxygen battery further includes a gas flow field, the control module including a valve disposed between the cathode and the gas flow field.

15. The battery system of claim 13, wherein the metal oxygen battery, the control module, and the oxygen containment unit are in a closed-loop with respect to each other.

16. The battery system of claim 4, further comprising a control module regulating oxygen flow from the oxygen containment unit to the metal oxygen battery through the conduit.

17. The battery system of claim 13 wherein the control module increases, decreases and/or stops oxygen flow from the oxygen containment unit to the metal oxygen battery.

18. The battery system of claim 1, wherein the oxygen containment unit has a first operating state of oxygen absorption into the oxygen storage material and a second operating state of oxygen desorption from the oxygen storage material, collectively defining a reversible operating state.

19. A battery system comprising:
a reversible closed-loop conduit communicating with an oxygen storage material and a metal oxygen battery, the reversible closed-loop conduit including an input and an output, the input of the reversible closed-loop conduit communicating with the output of the metal oxygen battery and the output of the reversible closed-loop conduit communicating with the input of the oxygen storage material.

20. A method of using a battery system, comprising:
communicating oxygen from a metal oxygen battery into a reversible closed-loop conduit; and
communicating oxygen to an oxygen storage material from the reversible closed-loop conduit.
